(19) United States
(12) Patent Application Publication
(10) Pub. No.: US 2025/0201245 A1
(43) Pub. Date: Jun. 19, 2025

(54) INFORMATION PROCESSING APPARATUS

(71) Applicant: TOYOTA JIDOSHA KABUSHIKI KAISHA, Toyota-shi (JP)

(72) Inventors: Keiko NAKANO, Kawasaki-shi (JP); Kaori YAMADA, Nagakute-shi (JP); Chikage KUBO, Chofu-shi (JP); Eiichi MAEDA, Asaka-shi, Saitama-ken (JP); Reona GOMI, Nagoya-shi (JP); Masatoshi TERADA, Yamato-shi (JP)

(73) Assignee: TOYOTA JIDOSHA KABUSHIKI KAISHA, Toyota-shi (JP)

(21) Appl. No.: 18/966,122

(22) Filed: Dec. 3, 2024

(30) Foreign Application Priority Data
Dec. 13, 2023 (JP) 2023-210378

(51) Int. Cl. G10L 15/22; G10L 15/08

(52) U.S. Cl. CPC G10L 15/22; G10L 15/08; G10L 2015/088; G10L 2015/223; G10L 2015/225

(57) ABSTRACT

An information processing apparatus includes a controller. Upon detecting an utterance that satisfies an utterance condition set in advance, the controller activates a voice assistant function and outputs a response to a content of the utterance, even if a keyword for activating the voice assistant function is not detected.

### CROSS-REFERENCE TO RELATED APPLICATION

This application claims priority to Japanese Patent Application No. 2023-210378 filed on Dec. 13, 2023, the entire contents of which are incorporated herein by reference.

### TECHNICAL FIELD

The present disclosure relates to an information processing apparatus.

### BACKGROUND

Technology for activating a voice assistant function upon detecting a wake-up word included in an utterance voice of a user is known. See Patent Literature (PTL) 1.

### CITATION LIST

### Patent Literature

PTL 1: JP 2021-158578 A

### SUMMARY

There is room for improvement with respect to technology for activating a voice assistant function. For example, even if the utterance voice of the user does not include a wake-up word, there may be a situation in which the urgency of activating the voice assistant function is high, depending on the content of the utterance and the like.

It would be helpful to improve technology for activating a voice assistant function.

An information processing apparatus according to an embodiment of the present disclosure includes a controller configured to, upon detecting an utterance that satisfies an utterance condition set in advance, activate a voice assistant function and output a response to a content of the utterance, even if a keyword for activating the voice assistant function is not detected.

According to an embodiment of the present disclosure, technology for activating a voice assistant function can be improved.

### BRIEF DESCRIPTION OF THE DRAWINGS

In the accompanying drawings:

FIG. 1 is a block diagram of a vehicle according to an embodiment of the present disclosure;

FIG. 2 is a diagram illustrating an example of an interior of the vehicle illustrated in FIG. 1; and

FIG. 3 is a flowchart illustrating an example of processing procedures executed by an information processing apparatus illustrated in FIG. 1.

### DETAILED DESCRIPTION

An embodiment of the present disclosure will be described below, with reference to the drawings.

### (Configuration of Vehicle)

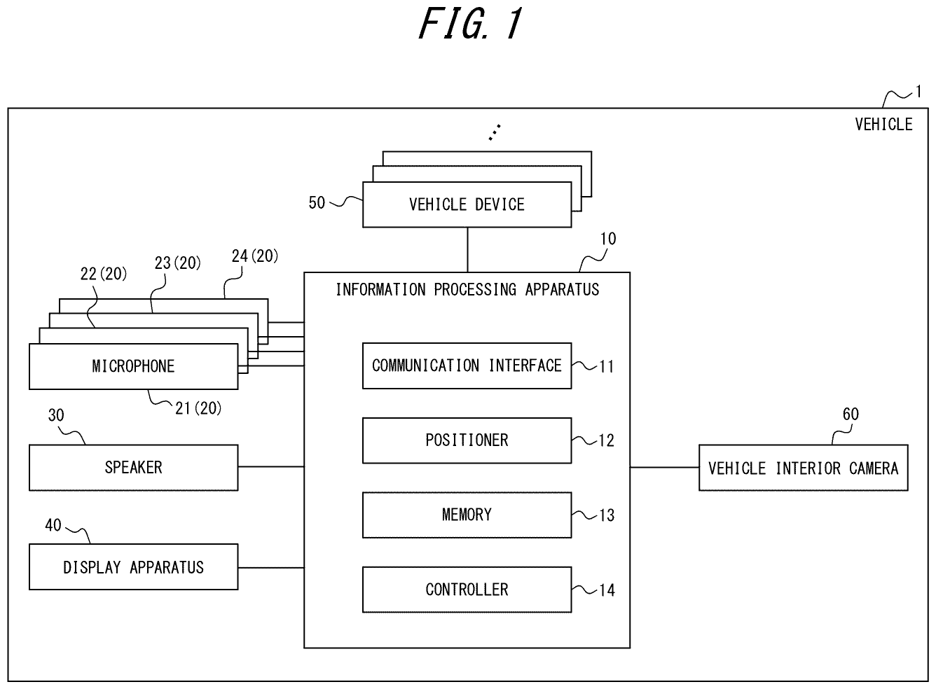

As illustrated in FIG. 1, a vehicle 1 for the present embodiment is equipped with an information processing apparatus 10, microphones 21, 22, 23, 24, a speaker 30, a display apparatus 40, and multiple vehicle devices 50. Hereinafter, the microphones 21, 22, 23, 24 are also described as the “microphone 20” unless particularly distinguished. The vehicle 1 may further be equipped with a vehicle interior camera 60.

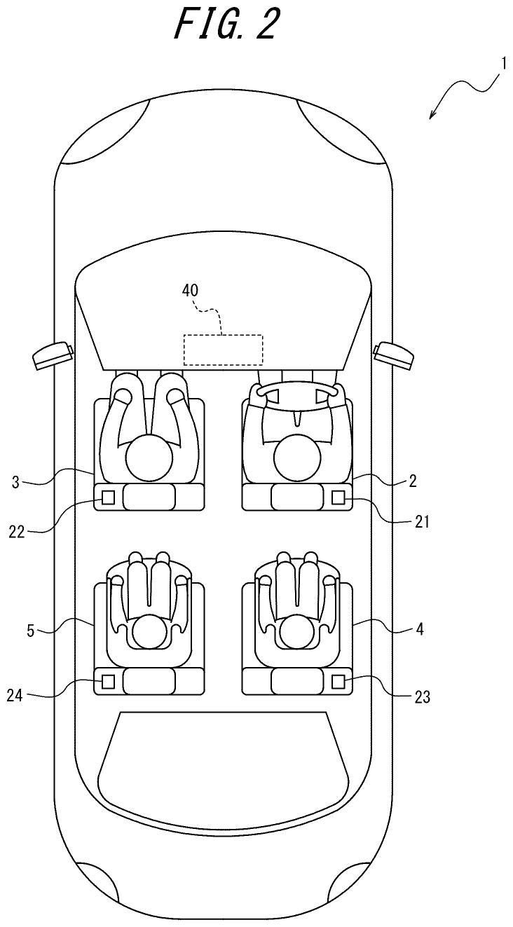

As illustrated in FIG. 2, the vehicle 1 has seats 2, 3, 4, 5. The seat 2 is the driver's seat. The seat 3 is the passenger seat. The seat 4 is the right seat of the two rear seats, facing the direction of travel. The seat 5 is the left seat of the two rear seats, facing the direction of travel. The seats 2 and 3 are occupied by adults. The seats 4 and 5 are occupied by children. In the present embodiment, the vehicle 1 has four seats. However, the vehicle 1 may have any number of seats.

The information processing apparatus 10 as illustrated in FIG. 1 has a voice assistant function. The information processing apparatus 10 may be any device as long as it has a voice assistant function.

The microphone 20 collects voices based on the control of the information processing apparatus 10. The microphone 20 transmits voice data including the collected voices to the information processing apparatus 10.

Each microphone 20 is located at a point where it can collect the voices of each user in the vehicle 1. For example, as illustrated in FIG. 2, the microphone 21 is located in the seat 2. The microphone 21 is positioned on the seat 2 and can collect the voices of the user seated in the seat 2. The microphone 22 is located at the seat 3. The microphone 22 is positioned on the seat 3 and can collect the voices of the user seated in the seat 3. The microphone 23 is located in the seat 4. The microphone 23 is located in the seat 4 and can collect the voices of the user seated in the seat 4. The microphone 24 is located at the seat 5. The microphone 24 is located at the seat 5 and can collect the voices of the user seated in the seat 5.

The speaker 30, as illustrated in FIG. 1, outputs voices based on the control of the information processing apparatus. The speaker 30 may be located anywhere in the interior of the vehicle 1.

The display apparatus 40 is, for example, a car navigation apparatus. The display apparatus 40 is configured to include a display. The display is, for example, a liquid crystal display (LCD), an organic electro-luminescent (EL) display, or the like.

The vehicle device 50 may be any equipment installed in the vehicle 1. The vehicle device 50 is, for example, air conditioners, actuators for opening and closing doors, windows, or sound equipment. The vehicle device 50 executes processes based on the control of the information processing apparatus 10.

The vehicle interior camera 60 generates video data by executing shooting based on the control of the information processing apparatus 10. The vehicle interior camera 60 transmits video data to the information processing apparatus 10. The vehicle interior camera 60 is located in the interior of the vehicle 1 where they can capture the face of each user.

### (Configuration of Information Processing Apparatus)

As illustrated in FIG. 1, the information processing apparatus 10 includes a communication interface 11, a positioner 12, a memory 13, and a controller 14.

The communication interface 11 is configured to include at least one communication module capable of communicating with various configurations of the vehicle 1. The communication module is a communication module compliant with a standard of an in-vehicle network such as a controller area network (CAN).

The communication interface 11 may be configured to include at least one communication module for connection to a network. The network may be any network including a mobile communication network, the Internet, or the like. The communication module is a communication module compliant with a mobile communication standard such as Long Term Evolution (LTE), 4th Generation (4G), or 5th Generation (5G).

The positioner 12 is capable of acquiring the positional information on the vehicle 1. The positioner 12 is configured to include at least one receiving module compliant with a satellite positioning system. The receiving module is, for example, a receiving module corresponding to the Global Positioning System (GPS).

The memory 13 is configured to include at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM), dynamic random access memory (DRAM), or the like. The ROM is, for example, Electrically Erasable Programmable Read Only Memory (EEPROM) or the like. The memory 13 may function as a main memory, an auxiliary memory, or a cache memory. A system program, an application program, embedded software, and the like may be stored in the memory 13. The memory 13 stores the data to be used for the operations of the information processing apparatus 10 and the data obtained by the operations of the information processing apparatus 10. For example, information is stored in the memory 13 that maps the microphones 21, 22, 23, 24 as illustrated in FIG. 2 to the seats 2, 3, 4, 5 where the microphones 21, 22, 23, 24 are located, respectively. Map information may also be stored in the memory 13.

The controller 14 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. Examples of dedicated circuits can include a Field-Programmable Gate Array (FPGA) and an Application Specific Integrated Circuit (ASIC). The controller 14 executes processes related to operations of the information processing apparatus 10 while controlling the components of the information processing apparatus 10. For example, the controller 14 controls the display apparatus 40 or the vehicle device 50 by transmitting control signals to the display apparatus 40 or the vehicle device 50 by the communication interface 11.

The controller 14 receives the voice data including the voices collected by the microphone 20 from the microphone 20 by means of the communication interface 11. The controller 14 performs voice recognition processing on the received voice data. Speech recognition processing is, for example, the process of converting voice data into character data. The controller 14 executes the voice recognition process and activates the voice assistant function when it detects the first keyword (keyword) for activating the voice assistant function from the received voice data. The voice assistant function controls the display apparatus 40 or the vehicle device 50 based on the content of the utterance of the user. Upon activating the voice assistant function, the controller 14 controls the display apparatus 40 or the vehicle device 50 based on the voice data received from the microphone 20. In other words, the controller 14 performs the voice assistant function. After executing the voice assistant function, the controller 14 puts the voice assistant function in a standby state.

Here, upon detecting an utterance that satisfies an utterance condition set in advance, the controller 14 activates the voice assistant function, even if the first keyword is not detected in the received voice data. The utterance condition may be set freely based on the content of the utterance with high urgency of activating the voice assistant function or the user's state. In the present embodiment, the utterance condition is a condition that the user who has uttered the utterance has a predetermined attribute set in advance and the content of the utterance of the user is a predetermined content set in advance.

The predetermined attribute set in advance in the utterance condition may be set considering the attributes of users who may be vulnerable in the interior of the vehicle 1. User attributes are characteristics or features of the user. Here, children or elderly persons can be vulnerable persons in the interior of the vehicle 1. Therefore, the predetermined attribute set in advance in the utterance condition may be a child or an elderly person. In the present embodiment, the predetermined attribute is assumed to be a child under a predetermined age. The predetermined age is, for example, 6 years old.

The predetermined content set in advance in the utterance condition may be a content with high urgency of activating the voice assistant function in the interior of the vehicle 1. When the controller 14 detects a second keyword set in advance in the voice data of the user, the controller 14 may determine that the content of the utterance of the user is the predetermined content set in advance. The second keyword may be set in consideration of the content of the utterance with high urgency of activating the voice assistant function. For example, if a child utters the utterance “I want to go to the restroom”, “I feel sick”, or “Help”, the urgency of activating the voice assistant function is greater than if an adult utters the utterance “I want to go to the restroom” or the like. In this case, the second keyword may be “I want to go to the restroom”, “I feel sick”, or “Help”.

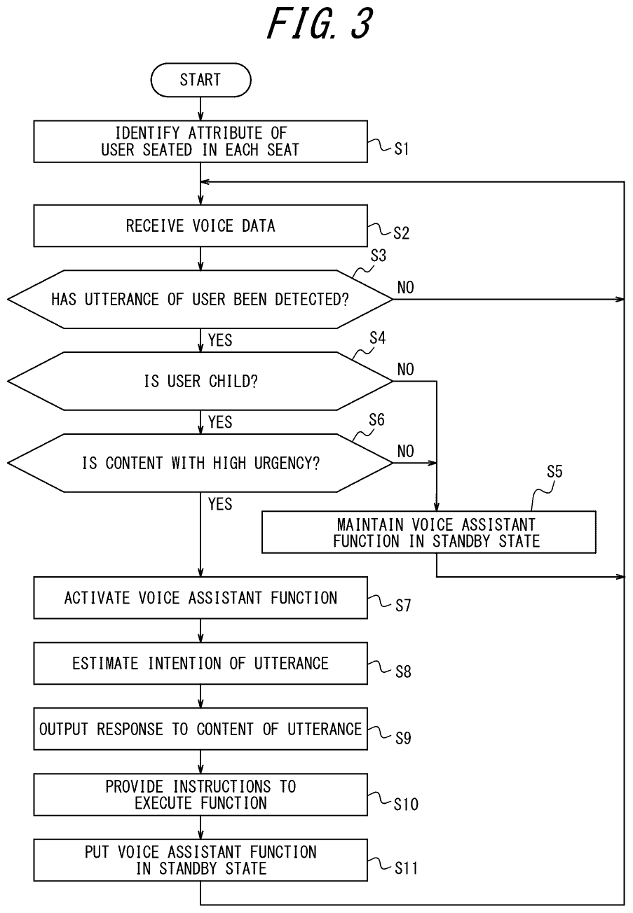

FIG. 3 is a flowchart illustrating an example of processing procedures executed by the information processing apparatus 10 illustrated in FIG. 1. Before the process of S1, the voice assistant function is in a standby state. The controller 14 starts the process of S1 when the ignition of the vehicle 1 is turned on, for example.

In the process of S1, the controller 14 receives the voice data of each user seated in the seats 2, 3, 4, 5 from each of the microphones 21, 22, 23, 24 by the communication interface 11. The controller 14 identifies an attribute of each user seated in the seats 2, 3, 4, and 5 by analyzing the voice data of each user seated in the seats 2, 3, 4, 5. In the present embodiment, the controller 14 identifies as the user attribute whether the user is a child at or under a predetermined age, or a child over the predetermined age or an adult. For example, the controller 14 identifies the attributes of the respective users seated in the seats 2 and 3 as adults by analyzing the voice data acquired from the microphones 21 and 22, respectively. The controller 14 identifies the attributes of the respective users seated in the seats 4 and 5 as children below a predetermined age by analyzing the voice data acquired from the microphones 23 and 24, respectively.

In the process of S2, the controller 14 receives the voice data from any of the microphones 21, 22, 23, 24 by the communication interface 11.

In the process of S3, the controller 14 determines whether or not the utterance of the user has been detected by performing speech recognition processing on the voice data received in the process of S2. If the controller 14 determines that the utterance of the user has been detected (S3: YES), the controller 14 proceeds to the process of S4. Conversely, in a case in which it is determined that the utterance of the user has not been detected (S3: NO), the controller 14 returns to the process of S2.

In the process of S4, the controller 14 determines whether the user whose utterance has been detected in the process of S3 is a child under a predetermined age. As an example of this process, first, the controller 14 identifies the seat where the microphone 20 that received the voice data in the process of S2 is located by the above mapping information stored in the memory 13. Next, the controller 14 identifies the attribute of the user seated in the identified seat based on the results of the process of S1. Furthermore, the controller 14 determines whether the attribute of the identified user is a child under a predetermined age. For example, assume that the microphone 20 that received the voice data in the process of S2 is the microphone 23. In this case, the controller 14 first identifies the seat 4 where the microphone 23 is located by the above mapping information stored in the memory 13. Next, the controller 14 identifies the attribute of the user of the identified seat 4 as a child below a predetermined age based on the result of the process of S1. Furthermore, the controller 14 determines that the user whose utterance has been detected in the process of S3 is a child below a predetermined age.

If the controller 14 determines that the user whose utterance has been detected in the process of S3 is not a child under the predetermined age (S4: NO), the controller 14 proceeds to the process of S5. On the other hand, if the controller 14 determines that the user whose utterance has been detected in the process of S3 is a child under the predetermined age (S4: YES), the controller proceeds to the process of S6.

In the process of S5, the controller 14 maintains the voice assistant function in a standby state. After the process of S5, the controller 14 returns to the process of S2.

In the process of S6, the controller 14 determines whether the content of the utterance detected in the process of S3 is a content with high urgency of activating the voice assistant function. If the controller 14 has detected the second keyword in the voice data of the user received in the process of S2, the controller 14 determines that the content of the utterance detected in the process of S3 is a content with high urgency of activating the voice assistant function.

If the controller 14 determines that the content of the utterance detected in the process of S3 is not a content with high urgency (step S6: NO), the controller 14 proceeds to the process of step S5. On the other hand, if the controller 14 determines that the content of the utterance detected in the process of S3 is the content with high urgency (step S6: YES), the controller 14 proceeds to the process of S7.

In the process of S7, the controller 14 activates the voice assistant function.

In the process of S8, the controller 14 estimates the intention of the utterance detected in the process of S3. The controller 14, for example, estimates the intention of the utterance detected in the process of S3 by performing natural language processing on the voice data received in the process of S2.

In the process of S9, the controller 14 outputs a response to the content of the utterance based on the intention of the utterance estimated in the process of S8.

As an example of the process of S9, if the controller 14 estimates that the intention of the utterance is “I want to go to the restroom” in the process of S8, the positional information for the vehicle 1 is acquired by the positioner 12. The controller 14 refers to the map information stored in the memory 13 to acquire information on restrooms located within a predetermined range from the location of the vehicle 1. The predetermined range is the range within which the vehicle 1 can arrive in a relatively short time, such as 10 minutes, for example. When the controller 14 acquires the information on the restroom, it transmits a control signal to the display apparatus 40 by the communication interface 11, thereby causing the display apparatus 40 to display an indication asking whether or not to guide the user to the restroom as a response to the intention of the utterance estimated in the process of S8. For example, if there is a convenience store with restrooms within a predetermined range from the location of the vehicle 1, the controller 14 will ask, “There is a restroom at a nearby convenience store. Would you like to be guided?” is displayed on the display apparatus 40. The controller 14 may cause the speaker 30 to output voice data of the response “There is a restroom at a nearby convenience store. Do you want me to show you?” by transmitting a control signal to the speaker 30 by means of the communication interface 11.

As another example of the process of S9, if the controller 14 estimates that the intention of the utterance is “I feel sick” in the process of S8, the control signal is transmitted to the speaker 30 by the communication interface 11 to cause the speaker 30 to output an inquiry as to whether to open the window. For example, the controller 14 causes the speaker 30 to output voice data of the response “Would you like to open a window?”.

In the process of S10, the controller 14 outputs instructions to execute functions to the display apparatus 40 or the vehicle device 50 to execute functions according to the user's response to the response output in the process of S9. The controller 14 may accept the user's response to the response as voice data from the microphone 20.

As an example of the process of S10, the controller 14 is assumed to acquire, in the process of S9, an affirmative response of “Yes” from the user in response to the response “There is a restroom at a nearby convenience store. Would you like me to show you?”. In this case, the controller 14 outputs, as instructions to execute a function in response to the user's response, instructions to the display apparatus 40, which is a car navigation device, to execute directions to the restroom. The controller 14 outputs instructions to the display apparatus 40 to execute directions to the restroom by transmitting control signals to the display apparatus 40 by the communication interface 11. Upon receiving the instructions, the display apparatus 40 superimposes a list of restrooms near the vehicle 1 on the map data. The display apparatus 40 executes directions to the restroom selected by the user from the displayed list of restrooms.

As another example of the process of S10, the controller 14 shall acquire from the user an affirmative response of “Yes” to the response “Do you want to open the window?” in the process of S9. In this case, the controller 14 outputs an instruction to open the window to the vehicle device 50, which is the actuator for opening and closing the window, as instructions to execute the function in response to the user's response. The controller 14 outputs instructions to the vehicle device 50 to open the windows by transmitting control signals to the vehicle device 50 by the communication interface 11.

In the process of S11, the controller 14 puts the voice assistant function in a standby state after execution of the voice assistant function. After processing S11, the controller 14 returns to the process of S2.

Here, in the processes from S1 to S11, the controller 14 may terminate the process procedures as illustrated in FIG. 3 when the ignition of the vehicle 1 is turned off.

Thus, in the information processing apparatus 10 of the present embodiment, upon detecting an utterance that satisfies the utterance condition set in advance, the controller 14 activates the voice assistant function, even if the first keyword (keyword) for activating the voice assistant function is not detected. In addition, the controller 14 outputs a response to the content of the utterance. With this configuration, even if the first keyword is not included in the utterance uttered by the user, if the content of the utterance is urgent enough to activate the voice assistant function, the voice assistant function can be activated promptly. Thus, according to the present embodiment, technology for activating the voice assistant function can be improved.

Furthermore, in the present embodiment, the utterance condition may be the condition that the user who has uttered the utterance has a predetermined attribute set in advance and the content of the utterance of the user is a predetermined content set in advance. Furthermore, a predetermined attribute may be a child. The predetermined content may be a content with high urgency of activating the voice assistant function in the interior of the vehicle. With this configuration, for example, even if the child does not utter the first keyword, if the child utters an urgent utterance, the voice assistant function can be activated promptly. In addition, responses to the content of the utterance can be output.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the process of S1, the controller 14 is described as identifying the attribute of each of the users seated in the seats 2, 3, 4, 5 by the voice data of each of the users seated in the seats 2, 3, 4, 5 received from the respective microphones 21, 22, 23, 24. However, the controller 14 may identify the attributes of the users seated in the seats 2, 3, 4, and 5 by analyzing the video data received by the communication interface 11 from the vehicle interior camera 60.

For example, the controller 14 need not perform the process of S1. In this case, in the process of S4, the controller 14 may identify the attributes of the user by analyzing the voice data of the user received in the process of S2. The controller 14 may determine whether or not the user whose utterance has been detected in the process of S3 is a child under a predetermined age according to the identified attributes of the user (S4).

For example, in the process of S6, the controller 14 is described as judging that the content of the utterance detected in the process of S3 is a content with high urgency of activating the voice assistant function when the second keyword has been detected in the voice data of the user received in the process of S2. However, the controller 14 may use any method other than the second keyword to determine whether the content of the utterance detected in the process of S3 is a content with high urgency of activating the voice assistant function. As another example, the controller 14 may estimate the user's emotion by analyzing the voice data of the user received in the process of S2. Based on the estimated user emotion, the controller 14 may determine whether the content of the utterance detected in the process of S3 is a content with high urgency of activating the voice assistant function.

For example, in the embodiment described above, the predetermined attribute set in advance in the utterance condition is assumed to be a child. However, a predetermined attribute is not limited to children. As another example, a predetermined attribute may be elderly. In this case, the elderly person may be a person at or above an age set in advance. The set age may be set by considering the age of those who may be vulnerable due to their advanced age in the interior of the vehicle 1.

For example, in the embodiment described above, the information processing apparatus 10 is assumed to be mounted in the vehicle 1. However, the information processing apparatus 10 need not be mounted in the vehicle 1. As another example, the information processing apparatus 10 may be a cloud server. In this case, the vehicle 1 may be equipped with a communication device that can communicate with the information processing apparatus 10, which is a cloud server.

1. An information processing apparatus comprising a controller configured to, upon detecting an utterance that satisfies an utterance condition set in advance, activate a voice assistant function and output a response to a content of the utterance, even if a keyword for activating the voice assistant function is not detected.

2. The information processing apparatus according to claim 1, wherein the utterance condition is a condition that a user who has uttered the utterance has a predetermined attribute set in advance and the content of the utterance of the user is a predetermined content set in advance.

3. The information processing apparatus according to claim 2, wherein the predetermined attribute is a child.

4. The information processing apparatus according to claim 2, wherein the predetermined content is a content with high urgency of activating the voice assistant function in an interior of a vehicle.

5. The information processing apparatus according to claim 4, wherein the predetermined content is a content of a request to go to a restroom.
